(19) United States
(12) Patent Application Publication
(10) Pub. No.: US 2005/0022436 A1
(43) Pub. Date: Feb. 3, 2005

(54) Visual image display and process for creating a unique visual image

(76) Inventors: Corky Lehmkuhl, Los Angeles, CA (US); Casper Brindle, Culver City, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/859,441

(22) Filed: Jun. 1, 2004

Related U.S. Application Data
(60) Provisional application No. 60/474,343, filed on Jun. 2, 2003.

(51) Int. Cl. G09F 19/12

(52) U.S. Cl. 40/427; 40/716

(57) ABSTRACT

A visual image display includes a first substrate having front and back surfaces. A first image is disposed on the front surface of the first substrate. The display also includes a light source for illuminating the back surface of the first substrate, and a second image is disposed between the light source and the first image. The first substrate is at least partially translucent so that the second image is visible on the front surface of the first substrate when illuminated by the light source. Only the first image is visible in the display when the second image is not illuminated. A process for creating a visual image includes placing the first image on the front surface of the first substrate. The second image is provided behind the first image and illuminated to create a composite of the first and second images on the first substrate.

### RELATED APPLICATION

This application claims the benefit of U.S. Provisional Application No. 60/474,343, filed Jun. 2, 2003.

### BACKGROUND OF THE INVENTION

The present invention generally relates to visual displays. More particularly, the present invention relates to a visual image display and a process for creating a unique visual image.

Conventional image displays typically include a frame and an image, typically in the form of one or more photographs or drawings, held within the frame. However, while conventional displays have been in use for many years, they have drawbacks related to the manner in which the images held within can be displayed. The more images a user desires to display in a single frame, the larger the frame necessarily becomes to hold the images.

Various displays have been proposed to address such problems. In one example, U.S. Pat. No. 4,282,669 is directed to an illuminated picture frame for displaying multiple or composite pictures. Several images can be displayed at the same time. However, only a single image can be seen at any one time depending on the viewing angle of the person and the position of the display with respect to the viewer. Also, the images must be specially created in sections rather than as a whole image. In a further example, U.S. Pat. No. 5,657,563 discloses an illuminated picture frame comprising a one way mirror having a picture visible when illuminated. However, there is no picture displayed when the frame is not illuminated. In another example, U.S. Pat. No. 5,899,012 discloses a framed artwork display. The display is intended to display translucent artworks. However, only a single image is able to be displayed at any one time.

Accordingly, there is a need for a display that allows a user to view a number of images concurrently. There is a further need for a display that merges the images being displayed. The present invention satisfies these needs and provides other related advantages.

### SUMMARY OF THE INVENTION

The present invention, in the form of a visual image display and a process for creating a unique visual image, represents an improvement over previous displays in that it can function not only as a conventional display, but is also able to display amalgamated images.

An embodiment of the present invention resides in a visual image display including a first substrate having front and back surfaces. A first image is disposed on the front surface of the first substrate. The display also includes a light source for illuminating the back surface of the first substrate, and a second image is disposed between the light source and the first image. The first substrate is at least partially translucent so that the second image is visible on the front surface of the first substrate when illuminated by the light source. However, when the second image is not illuminated, only the first image is visible in the display.

The second image is disposed on the back surface of the first substrate. However, when the display includes an at least partially translucent second substrate between the first substrate and the light source, the second image can be disposed on a surface of the second substrate. A third image may also be disposed on a surface of the second substrate. The third image is visible on the front surface of the first substrate only when illuminated by the light source.

The display also includes a housing having an opening and an inner chamber. The first substrate is supported within the housing and is aligned with the opening. The light source is disposed within the inner chamber. An opaque border is positioned adjacent the opening and surrounds the first image.

The housing also includes a removable planar backing for providing a user with access to the inner chamber.

Another embodiment of the present invention resides in a process for creating a visual image. The process includes placing the first image on the front surface of the at least partially translucent first substrate. The second image is provided behind the first image, and the second image is illuminated to create a composite of the first and second images on the front surface of the first substrate.

The second image is placed on a back surface of the first substrate. However, when an at least partially translucent second substrate is provided that is disposed adjacent to a back surface of the first substrate, the second image can be placed on a surface of the second substrate. A third image may be placed on a surface of the second substrate and the third image illuminated to create a composite of the first, second and third images on the front surface of the first substrate.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an orthogonal view of a visual image display embodying the present invention when not illuminated;

FIG. 2 is a front elevational view of the visual image of FIG. 1;

FIG. 3 is a front elevational view of the visual image of FIG. 1 when illuminated;

FIG. 4 is a front elevational view of another embodiment of a visual image display of FIG. 1 when illuminated;

FIG. 5 is a front elevational view of a rear frame of the visual display of FIGS. 1-4;

FIG. 6 is a front elevational view of a border of the visual display of FIGS. 1-4;

FIG. 7 is a front elevational view of a transparent substrate of the visual display of FIGS. 1-4;

FIG. 8 is a front elevational view of a front frame of the visual display of FIGS. 1-4;

FIG. 9 is a front elevational view of a first image on a first substrate of the visual display of FIGS. 1-4;

FIG. 10 is a front elevational view of a second image on the first substrate of the visual display of FIGS. 1-4;

FIG. 11 is a front elevational view of a third image on a second substrate of the visual display of FIG. 4;

FIG. 12 is an exploded orthogonal view the visual image display of FIG. 3; and

FIG. 13 is an exploded orthogonal view of the visual image display of FIG. 4.

### DETAILED DESCRIPTION OF THE PREFERRED EMBODIMENT

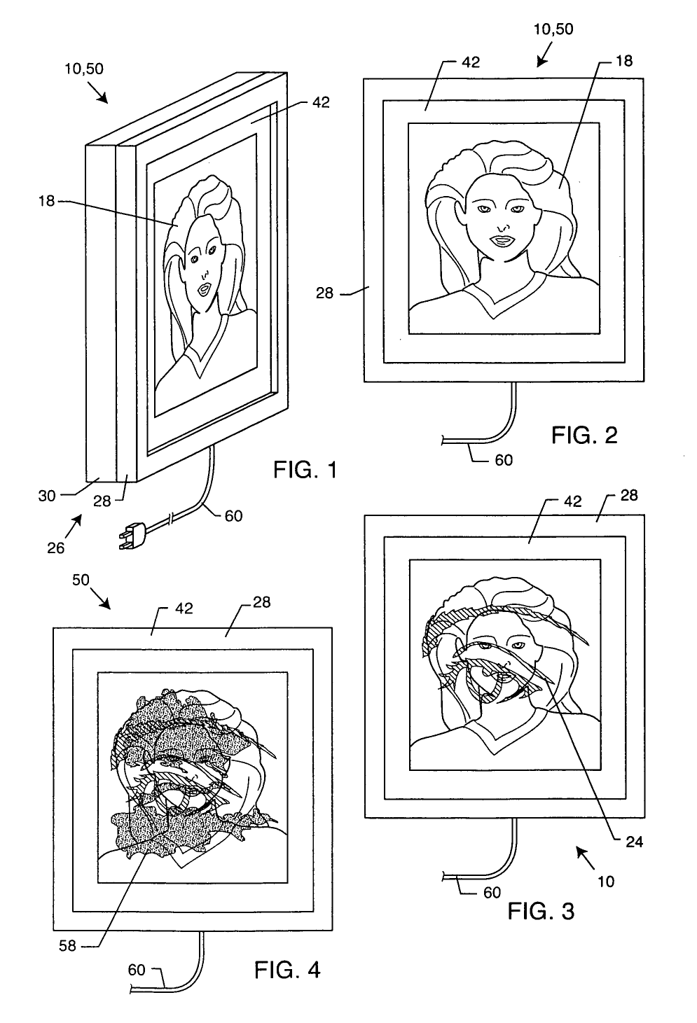

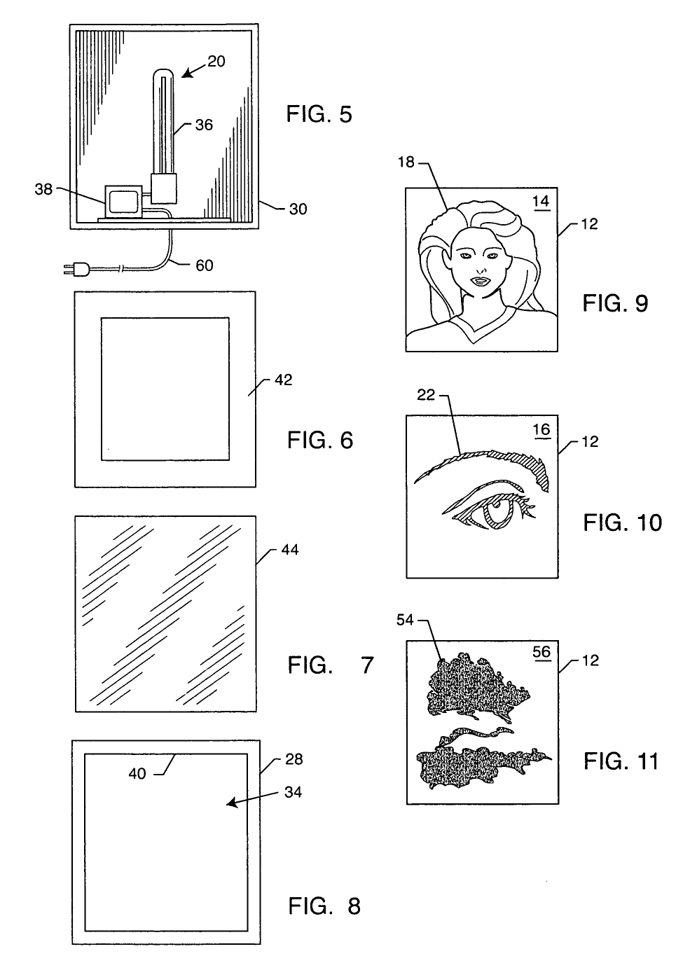

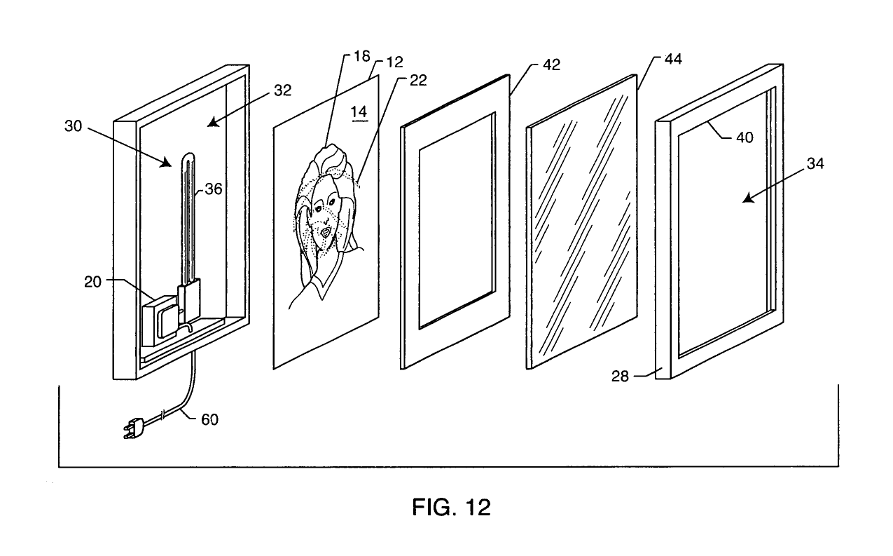

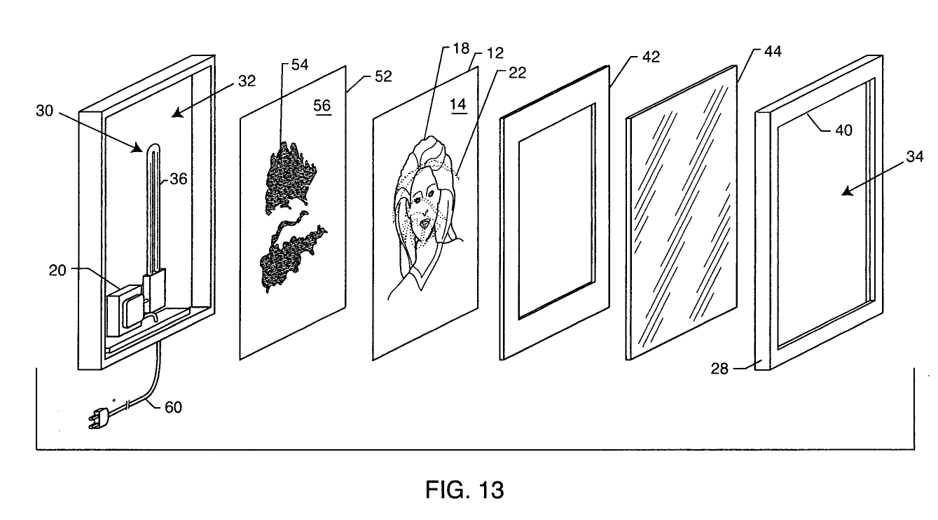

As shown in the drawings for purposes of illustration, the present invention resides in improved visual image display and process for creating a unique visual image. The displays embodying this invention are referred to by the reference number 10 in FIGS. 1-3, 5-10 and 12, and by the reference number 50 in FIGS. 1, 2, 4-11 and 13. While each illustrated embodiment differs from the others in features and construction, they are all functionally equivalent.

As illustrated in FIGS. 1-3, 5-10 and 12, an embodiment of the present invention resides in a visual image display 10 including a substantially planar first substrate 12 having front and back surfaces 14, 16. A first image 18 is disposed on the front surface 14 of the first substrate 12. The display 10 also includes a light source 20 for illuminating the back surface 16 of the first substrate 12, and a second image 22 is disposed between the light source 20 and the first image 18. The second image 22 is disposed on the back surface 16 of the first substrate 12. The first substrate 12 is at least partially translucent so that the second image 22 is visible on the front surface 14 of the first substrate 12 when illuminated by the light source 20. When a user views the illuminated display 10, the user sees a composite, collage, amalgamated or merged image 24 of the first and second images 18, 22 (FIG. 3). However, when the second image 22 is not illuminated, only the first image 18 is visible in the display 10 (FIGS. 1 and 2).

The display 10 includes a frame 26 having a front and rear sections 28, 30. The frame 26 acts as a housing for the first substrate 12 and the light source 20. The frame 26 forms an inner chamber 32 when the front and rear sections 28, 30 are joined. The front section 28 includes an opening 34 on the front. The light source 20 is disposed within the inner chamber 32 adjacent to the substrate 12 and oriented so that the light-emitting portion of the light source 20 extends over a portion of the back surface 16 of the substrate 12. As shown, the light source 20 includes a large U-shaped neon light source 36 electrically connected to a transformer 38. In an alternative, the light source 20 can be in the form of four tubular light sources disposed within the chamber 32 with their light-emitting portions extending towards the central portion of the substrate 12 so as to substantially illuminate the back surface 16 of the substrate 12.

An annular lip 40 extends around the internal perimeter of the front section 28 of the frame 26. The light source 20 and substrate 12 are sandwiched between the front and rear sections 28, 30 of the frame. The substrate 12 is supported within the inner chamber 32 on the annular lip 40 and aligned with the front opening 34. An opaque matte or border 42 and a substantially transparent sheet or substrate 44, in the form of a plastic or glass sheet, are positioned adjacent the opening 34, between the annular lip 40 and the substrate 44. The border 42 surrounds the first image 18. The frame 26 is generally rectangular but may also be square, oval, circular, triangular or any polygonal shape. In an alternative, the rear section 30 of the frame 26 includes a removable planar frame backing so as to provide access to the inner chamber 32 when the sections 28, 30 of the frame 26 are joined. The frame backing may be removably attachable to the frame 26 by any conventional fastener.

Another embodiment of the present invention resides in the visual image display 50, as shown in FIGS. 1, 2, 4-11 and 13. The display 50 is nearly identical in form and function to the display 10 described above, except that the display 50 includes a second substrate 52 with a third image 54 disposed on a surface 56 of the second substrate 52. The third image 54 can be disposed on either the front or rear surface of the second substrate 52. The second substrate 52, disposed between the first substrate 12 and the light source 20, is at least partially translucent so that the third image 54 is visible on the front surface 14 of the first substrate 12 when illuminated by the light source 20. When a user views the illuminated display 10, the user sees a composite, collage, amalgamated or merged image 58 of the first, second and third images 18, 22, 54. However, when the second and third images 22, 54 are not illuminated, only the first image 18 is visible in the display 50.

The light source 20 can include a number of light sources in various forms including, but not limited to, flourescent, neon, incandescent, light-emitting diodes, liquid crystal display. In an alternative, the light source can include a tubular light source and a generally planar, rectangular light guide with the tubular light source positioned along one side of the light guide so that the light emitted from the light source is diffused within the light guide. The light source 20 is secured within the frame 26 by any conventional method and arranged within the inner chamber 32 so that a substantial portion of the light source 20 is aligned with the images 18, 22, 54.

Alternatively, when the display 50 includes the second substrate 52, the second image 22 can be disposed on the front surface 56 of the second substrate 52. In another alternative, the second image 22 can be disposed on the front surface 56 and the third image 54 can be disposed on a rear surface of the second substrate 52. In yet another alternative, when the display 50 includes the second substrate 26, an image may be placed on each of the front and rear surfaces of the first and second substrates 12, 52 for a total of four images that can be viewed as an amalgamated image when the display 50 is illuminated by the light source 20.

The images 18, 22, 54 are affixed to the surfaces of the first and/or second substrate 12, 52 by various methods including, without limitation, photographically, by way of printing, or by hand. The first and second substrates 12, 52 may be made from various materials including, without limitation, photographic paper, paper, vellum, fabric, plastic, Mylar or any other at least partially translucent or transparent material.

A power cord 60 extends from an electrical wall socket (not shown) or the like and into the frame 26 through an aperture (not shown) where the cord 60 is mechanically and electrically connected to the light source 20. In an alternative, the power source can be a battery (rechargeable or non-rechargeable) that is electrically connected to the light source 20.

In use, a user places the first image 18 on the front surface 14 of the first substrate 12. The second image 22 is provided behind the first image 18. The second image 22 is illuminated to create a composite image 24 of the first and second images 18, 22 on the front surface 14 of the first substrate 12. The images 18, 22 are illuminated by backlighting which may be achieved with or without a frame 26.

As discussed above, the second image 22 is placed on the back surface 16 of the first substrate 12 but when the second substrate 52 is provided adjacent to the back surface 16 of the first substrate 12, the second image 22 can be placed on a surface 56 of the second substrate 52. The third image 54 may be placed on any surface 56 of the second substrate 52 and the third image 54 illuminated to create a composite image 58 of the first, second and third images 18, 22, 54 on the front surface 14 of the first substrate 12.

Although several embodiments have been described in detail for purposes of illustration, various modifications may be made without departing from the scope and spirit of the invention.

1. A visual image display, comprising:
an at least partially translucent first substrate having front and back surfaces;
a first image disposed on the front surface of the first substrate;
a light source for illuminating the back surface of the first substrate; and
a second image disposed between the light source and the first image, the second image being visible on the front surface of the first substrate only when illuminated by the light source.

2. The display of claim 1, wherein the second image is disposed on the back surface of the first substrate.

3. The display of claim 1, including an at least partially translucent second substrate between the first substrate and the light source.

4. The display of claim 3, wherein the second image is disposed on a surface of the second substrate.

5. The display of claim 3, including a third image disposed on a surface of the second substrate, the third image being visible on the front surface of the first substrate only when illuminated by the light source.

6. The display of claim 1, including a housing having an opening and an inner chamber, wherein the first substrate is aligned with the opening and the light source is disposed within the inner chamber.

7. The display of claim 6, including an opaque border positioned adjacent the opening and surrounding the first image.

8. The display of claim 6, wherein the first substrate is supported within the housing.

9. The display of claim 6, wherein the housing includes a removable planar backing for providing access to the inner chamber.

10. A process for creating a visual image, comprising the steps of:
placing a first image on a front surface of an at least partially translucent first substrate;
providing a second image behind the first image; and
illuminating the second image to create a composite of the first and second images on the front surface of the first substrate.

11. The process of claim 10, including the step of placing the second image on a back surface of the first substrate.

12. The process of claim 10, including the step of providing an at least partially translucent second substrate disposed adjacent to a back surface of the first substrate.

13. The process of claim 12, including the step of placing the second image on a surface of the second substrate.

14. The process of claim 12, including the steps of placing a third image on a surface of the second substrate, and illuminating the third image to create a composite of the first, second and third images on the front surface of the first substrate.

15. A process for creating a visual image, comprising the steps of:
placing a first image on a front surface of an at least partially translucent first substrate;
providing a second image behind the first image;
placing the second image on a back surface of the first substrate;
providing an at least partially translucent second substrate disposed adjacent to a back surface of the first substrate;
placing a third image on a surface of the second substrate; and
illuminating the third image to create a composite of the first, second and third images on the front surface of the first substrate.

16. A visual image display, comprising:
an at least partially translucent first substrate having front and back surfaces;
a first image disposed on the front surface of the first substrate;
a light source for illuminating the back surface of the first substrate;
a second image disposed on the back surface of the first substrate between the light source and the first image;
an at least partially translucent second substrate between the first substrate and the light source; and
a third image disposed on a surface of the second substrate, the second and third images being visible on the front surface of the first substrate only when illuminated by the light source.

17. The display of claim 16, including a housing having an opening and an inner chamber; wherein the first substrate is aligned with the opening and the light source is disposed within the inner chamber.

18. The display of claim 17, including an opaque border positioned adjacent the opening and surrounding the first image; wherein the first substrate is supported within the housing.

19. The display of claim 18, wherein the housing includes a removable planar backing for providing access to the inner chamber.
